(19) United States
(12) Patent Application Publication
(10) Pub. No.: US 2007/0150406 A1
(43) Pub. Date: Jun. 28, 2007

(54) Bidder monitoring tool for integrated auction and product ordering system

(75) Inventors: Lenin K. Subramanian, Palo Alto, CA (US); Yan Cui, Sunnyvale, CA (US); Zhong Zhang, Los Altos, CA (US)

Correspondence Address: KENYON & KENYON LLP, 1500 K STREET N.W., WASHINGTON, DC, 20005, US

(73) Assignee: SAP AG

(21) Appl. No.: 11/591,165

(22) Filed: Oct. 31, 2006

Related U.S. Application Data
(60) Provisional application No. 60/731,257, filed on Oct. 31, 2005.

(51) Int. Cl. G06Q 40/00

(52) U.S. Cl. 705/37

(57) ABSTRACT

A monitoring tool that permits a buyer to search for and participate in auctions conducted on a website of the buyer's vendor. The monitoring tool provides a navigation frame having entries therein that represent predetermined searches across both the enterprise auction system and the enterprise product ordering and fulfillment system. The monitoring tool also provides a product description frame that provides summary records of auctions that are relevant to a selected view. By selecting among the navigation entries, a bidder is able to navigate quickly and accurately to auction information that is most relevant to his operations.

### BACKGROUND

Sellers of goods and services often use computer systems to manage their operations. Some of them use product ordering and fulfillment applications to store data representing their products, to maintain data of product inventory as it changes over time, to manage data regarding their customers (including for example, an identification of which products are eligible for purchase by each customer) and to maintain price books, which determine what prices are to be offered to individual customers.

Sellers often seek to find alternative ways to sell their products. Recently, interest has developed in automated auctions for products. Automated auction systems typically are maintained by an auctioneering authority, a company which has no predetermined affiliation with various sellers who use the conventional product ordering and fulfillment applications. While sellers can manually open auctions and define terms under which they will sell their products in an auction managed by a third party, the manual operations are cumbersome. They do not provide a convenient means for a seller to identify its products and publish information about them and they do not integrate with the data structures already available to sellers via the product ordering and fulfillment centers that many of them maintain on their own. Accordingly, there is a need in the art for an enterprise system providing an auction system that is integrated with seller's product ordering and fulfillment systems. There further is a need in the art for such a system that provides secure communication between the auction system and the product ordering and fulfillment systems. There further is a need in the art for such an integrated system that provides a monitoring tool to permit bidders to review, control and possibly modify auctions as they occur and correlate them to with purchases they may have made under the product ordering and fulfillment application.

### BRIEF DESCRIPTION OF THE DRAWINGS

FIG. 1 is a simplified diagram of a computer system according to an embodiment of the present invention.

FIG. 2 illustrates a monitoring tool user interface according to an embodiment of the present invention.

FIG. 3 illustrates a monitoring tool user interface according to another embodiment of the present invention.

FIG. 4 illustrates a monitoring tool user interface according to a further embodiment of the present invention.

FIG. 5 illustrates a monitoring tool user interface according to another embodiment of the present invention.

FIG. 6 illustrates a monitoring tool user interface according to further embodiment of the present invention.

FIG. 7 illustrates a monitoring tool user interface according to another embodiment of the present invention.

### DETAILED DESCRIPTION

Embodiments of the present invention provide a monitoring tool that permits a buyer to search for and participate in auctions conducted on a website of the buyer's vendor. The monitoring tool provides a navigation frame having entries therein that represent predetermined searches across both the enterprise auction system and the enterprise product ordering and fulfillment system. The monitoring tool also provides a product description frame that provides summary records of auctions that are relevant to a selected view. By selecting among the navigation entries, a bidder is able to navigate quickly and accurately to auction information that is most relevant to his operations.

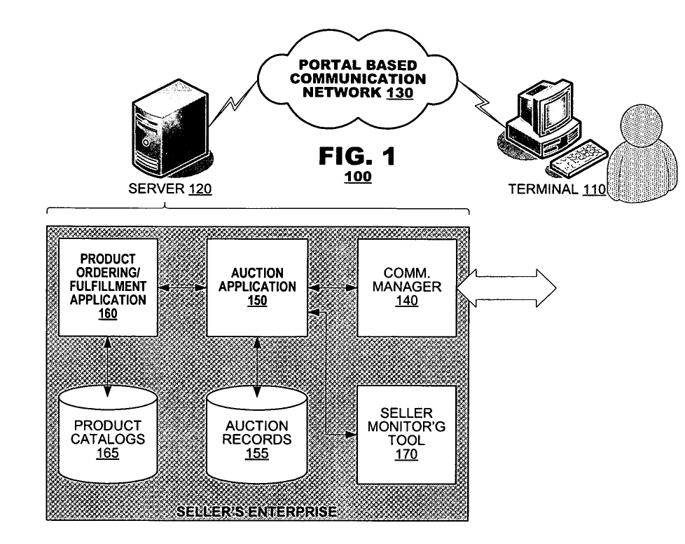

FIG. 1 illustrates an enterprise network 100 according to an embodiment of the present invention. There, the network 100 may include terminals 110 and servers 120 interconnected via a portal-based communication network 130. Although a single terminal 110 and a single server 120 are illustrated in FIG. 1, the number of terminals or servers may be varied to accommodate various enterprise installations. For the purposes of the present discussion, the number of components and topology of deployment is immaterial unless otherwise noted.

The servers 120 execute applications to manage operations of the seller. The servers 120 may execute applications representing a communication manager 140, an auction manager 150 and a product ordering and fulfillment manager 160. The communication manager 140 controls communication with the terminals. When responses to operator commands are required, the communication manager 140 generates portal pages and delivers them to the terminals. For example, the communication manager delivers portal pages representing the various user interfaces illustrated herein to the terminals.

The auction manager 150 is an application that generates and administers auctions. The auction manager 150 generates data records representing parameters of the various auctions maintained by the seller and stores data representing each auction's status. Similarly, the auction manager 150 stores data representing bids received from various bidders (via a communication process not shown) and, where appropriate, identifies winning bids for the auctions. Data records representing each auction may be stored in a dedicated auction database.

The product ordering and fulfillment manager 160 may manage other sales activity of a seller. For example, sellers often offer products for retail sale or for sale to distributors and other channel partners. Product ordering and fulfillment managers 160 may field electronic purchase requests filed by buyers, may compare orders contained in the requests against data records representing current inventories of a seller's products and initiate fulfillment of the orders if they can be filled. To that extent, product ordering and fulfillment managers 160 may include functionality to manage data of product inventory, to manage billing and to manage product fulfillment. The product ordering and fulfillment manager 160 may operate upon data representing a seller's product catalog, which contains data on each product, and may store one or more ‘price books’ representing the prices offered for the seller's products. Additionally, the product ordering and fulfillment manager 160 may operate data representing the seller's customers their ordering history to determine, for example, which products each customer is eligible to review and what prices are to be charged to each customer for the seller's products.

The product ordering and fulfillment manager 160 may generate data records representing the seller's products, its current inventory, price books and customer data. Such data records may be stored, for example, in database 165.

For ease of illustration, the monitoring tool of the foregoing embodiments is illustrated as a unit 170 separate from the auction manager 150. In many instances, however, the monitoring tool 170 may be provided as a function module within the auction manager 150. It may be provided as a fully integrated component of the auction manager 150.

As noted, the auction manager 150 and the product ordering and fulfillment manager 160 may be provided in a common enterprise network. As such, the auction manager 150 and product ordering and fulfillment manager 160 may be integrated in a manner that previously has not been possible in auction systems. For example, rather than store product information expressly in an auction record, auction records in the present system may include pointers to corresponding product records maintained by the product ordering and fulfillment manager 160. Additionally, an auction may be defined to be contingent upon events that can only be determined by the product ordering and fulfillment manager 160, such as numbers of units currently held in inventory. Accordingly, the integrated system is believed to provide an advance over prior systems where no such integration is possible.

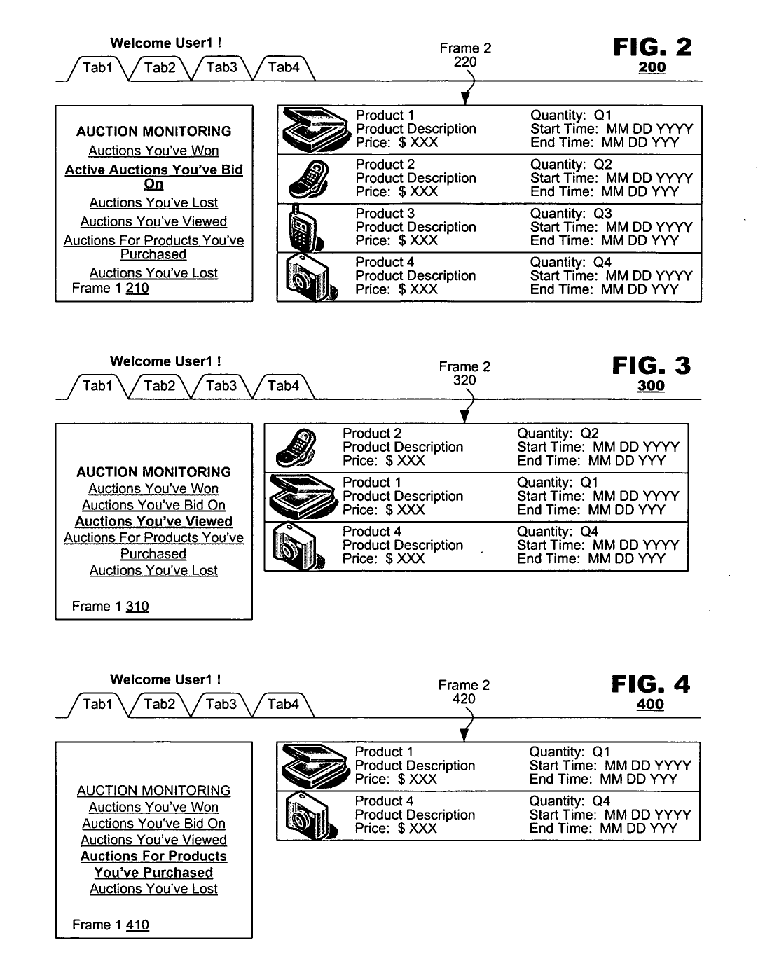

FIG. 2 is a simplified diagram of a user interface 200 generated by a bidder monitoring tool according to an embodiment of the present invention. There, the interface 200 may illustrate a navigation frame 210 and a product description frame 220 in two adjacent areas of the display. The navigation frame 210 lists various auction monitoring views of customer data that are available to the bidder. In the example of FIG. 2, the views include auctions the bidder has won, active auctions in which the bidder has placed a bid, auctions the bidder has lost, auctions the bidder has viewed and auctions that include products that the bidder has made ordinary purchases.

The product description frame 220 displays summary views of auction records that are responsive to each of the monitoring views. The summary views may include for example, image data displaying a picture of the product(s) up for bid in the respective auctions and summary data including, for example, an auction title, summary product description, current bid price, quantity of items within the auction and start and end times for the auction. The user interface may display the various summary views in an ordered list or other array and, if the number of auction records that are relevant to the currently selected monitoring view exceed a predetermined number, the interface may display the summary views in groups of a predetermined number (say, 20 per page).

The summary records displayed via interface 200 may be interactive. User interaction with a record may be interpreted by the server as a request for more detailed information than the summary view may provide. In this case, the server retrieves information from the auction database sufficient to create a detailed view (not shown) of the selected record. For example, the detailed view may identify terms of sale and provide additional information regarding the products and their condition. The detailed view also may include controls to permit the bidder to place a bid on the lot represented by the selected auction record. In an embodiment, when a bidder causes the server to generate a detailed view of an auction record, an identifier of the auction record may be added to a view history stored by the server in the bidder's profile.

FIG. 2 illustrates an exemplary presentation of data for a view that displays auctions in which the bidder has placed a bid. In an embodiment this view is presented by default when the bidder first logs on to the server 120 and navigates to the auction monitoring feature. Of course, the bidder can navigate to this view by express command, for example, by selecting the feature from the navigation frame 210 during presentation of some other view.

To displays auctions in which the bidder has placed a bid, the server may perform a search of the bidder's bid history to identify auctions in which the bidder has placed bids. Thereafter, the server may search through the identified auction records to identify searches that remain active. The server may develop summary views of the auction records and deliver them to the terminal in a rendered page.

FIG. 3 illustrates an exemplary presentation of data that may be made by the user interface 300 when a bidder elects to monitor auctions for which the bidder has previously viewed. Again, the user interface includes a pair of frames 310, 320. The navigation frame 310 continues to display the auction monitoring views that are available to the bidder. The second frame 320 displays products that are responsive to the selected view.

When the bidder elects to monitor auctions that the bidder has previously searched, the server executes a search for all auctions that appear in the bidder's view history and that are currently active. Auctions that are closed need not be retrieved. The server assembles a frame 320 in the rendered page that contains summary views of the responsive auctions and transfers the page to the terminal for display. Again, user interaction with one or more of the summary views may cause a detailed view of the responsive auction to be displayed, which also includes controls to permit the bidder to place bids on the auction.

FIG. 4 illustrates an exemplary presentation of data that may be made by the user interface 400 when a bidder elects to monitor auctions that relate to products that the bidder purchased from the customer in a traditional sales channel. Again, the user interface includes a pair of frames 410, 420. The navigation frame 410 continues to display the auction monitoring views that are available to the bidder. The second frame 420 displays products that are responsive to the selected view.

When the bidder elects to monitor auctions that contain products that the bidder previously purchased, the server executes a search among the bidder's purchasing data via the product ordering/fulfillment application. The product ordering/fulfillment application responds by identifying products that the bidder has purchased in some predetermined timeframe (say, six months, one year or throughout the bidder's entire purchasing history). Typically, such products are identified by a unique product ID or some other identifier. The server then searches among the auction records 155 to identify auction records that refer to the same product identifier and indicate they are currently active. The server populates the product description frame 420 of the user interface 400 with summary views of the responsive auction records and delivers a rendered page to the bidder's terminal 110.

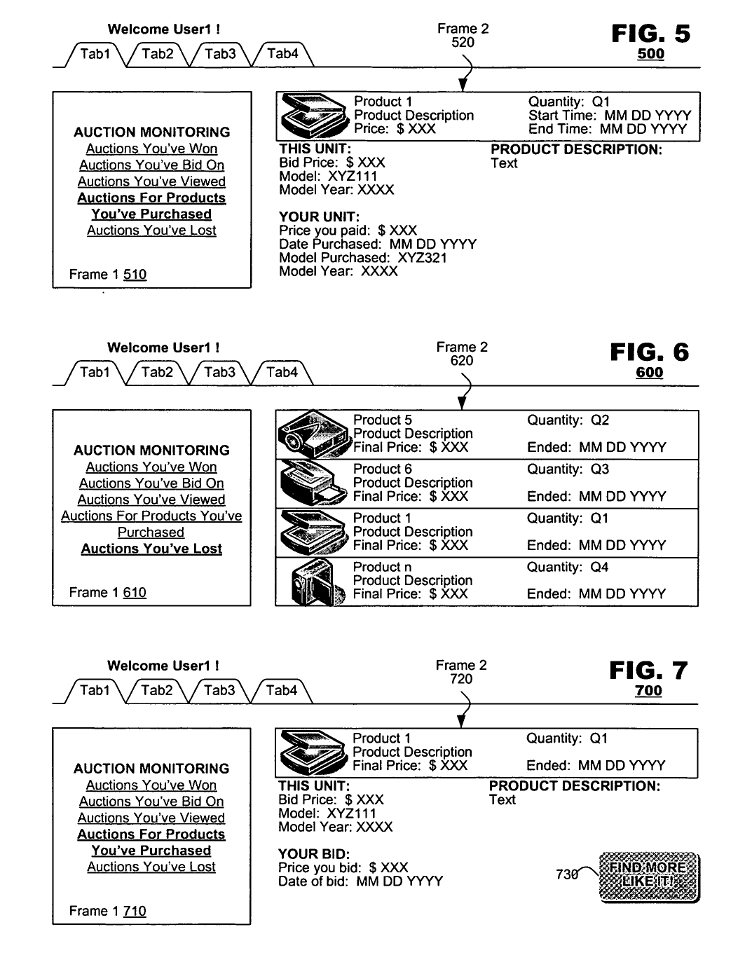

User interactivity with a summary view may case the server 120 to generate a detailed view of the auction record. In an embodiment, shown in FIG. 5, the detailed view may be supplemented to include data comparing parameters of the auction against the bidder's prior purchasing experience. For example, the detail view may compare the current bid price against the purchase price paid by the bidder in a prior transaction. The detail may compare product characteristics such as the make or model of the product and the year the product was made. Such data may be useful for a bidder to determine whether the terms of the auction compare favorably to the bidder's prior purchasing experience. As in foregoing embodiments, when the bidder causes the system to develop a detailed view of an auction record, an identifier of the auction record may be added to the bidder's view history.

FIG. 6 illustrates an exemplary presentation of data that may be made by the user interface 600 when a bidder elects to view auctions the bidder has bid on but lost. Again, the user interface includes a pair of frames 610, 620. The navigation frame 610 continues to display the auction monitoring views that are available to the bidder. The second frame 620 displays products that are responsive to the selected view.

When the bidder elects to view auctions that were lost, the server reviews the bidder's bid history to identify auctions on which the bidder has placed bids. The server then compares this set of auctions to a set of auctions the bidder won and removes the bidder's winning auctions from the set of auctions in which the bidder has placed bids. The server then retrieves records for the remaining auctions and determines which ones of them have concluded and a winner was awarded. The server 120 develops a rendered page with summary views of the responsive auction records and presents the page to the terminal.

Again, user interactivity with a summary view can cause the server to develop a detailed view of the auction record. Such an example is provided in FIG. 7. There, the detail view may provide additional detailed information regarding the product(s) offered for bid that was not provided in the summary view. The detail view also may provide information regarding the bidder's bid history, including for example the most recent price bid by the bidder. The detailed view, therefore, can provide a basis for comparing the bidder's offered price against the final price of the auction.

The detail view of a closed auction record may include a control 730 to permit the bidder to search for other auctions that have similar products. In response to a bidder command to find additional records, the server retrieves product identifiers from the record of the closed auction and uses the identifiers to search records of active auctions. From matching auction records, the server may assemble summary views of the responsive records and deliver them to the terminal.

The foregoing embodiments, therefore, provide an auction monitoring tool for bidders to search for and monitor progress of auctions of interest. The auction monitoring tool therefore provides a convenient tool for auction management by bidders. Further, because the auction application and product order/fulfillment application are integrated on a common enterprise network, the monitoring tool permits bidders to leverage their complete transaction history and search for an additional array of auctions of interest in a convenient manner.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. An integrated enterprise network comprising:
an auction management application and database therefore, the auction database storing records representing auctions of the enterprise,
a product ordering and fulfillment application and database therefore, the product ordering and fulfillment database storing records representing customer purchases,
an auction monitoring tool, comprising: a navigation frame presenting a plurality of monitoring views, each view corresponding to a search among one or more of the auction management database records and the product ordering and fulfillment database records, and
a search tool, responsive to operator selection of a monitoring view, to execute the corresponding search among the auction management database records and/or the product ordering and fulfillment database records and generate a results page representing search results obtained therefrom.

2. The network of claim 1, wherein one of the monitoring view comprises active auctions in which a user has placed a bid, the corresponding search causing a search of a prior bid history of the user and the auction records.

3. The network of claim 2, wherein the view of active auctions in which a user has placed a bid is the first of any auction views to be displayed.

4. The network of claim 1, wherein one of the monitoring views comprises active auctions the user has viewed in a detailed view, the corresponding search causing a search of a prior view history of the user and the auction records.

5. The network of claim 1, wherein one of the monitoring view comprises auctions that include products a user has purchased via the product ordering and fulfillment application, the corresponding search causing a search of the user's prior purchase history and the auction records.

6. The network of claim 1, wherein one of the monitoring view comprises auctions in which a user has placed a bid but lost the auction, the corresponding search causing a search of a prior bid history and records of closed auctions.

7. An auction monitoring method, comprising:
displaying a navigation frame representing a plurality of auction monitoring views available to a user, each auction monitoring view corresponding to a search among records of one of an auction application or a product ordering and fulfillment application,
displaying a product description frame representing auction record data responsive to a selected auction monitoring view,
when a monitoring view is selected, executing the corresponding search among records of the auction application and/or the product ordering and fulfillment application, and
populating the product description frame with summary views of auction records responsive to the search.

8. The method of claim 7, wherein one of the monitoring views comprises active auctions in which a user has placed a bid and the corresponding search causes a search of a prior bid history of the user and the auction records.

9. The method of claim 8, wherein the view of active auctions in which a user has placed a bid is the first of any auction views to be displayed.

10. The method of claim 7, wherein one of the monitoring views comprises active auctions the user has viewed in a detailed view and the corresponding search causes a search of a prior view history of the user and the auction records.

11. The method of claim 7, wherein one of the monitoring views comprises auctions that include products a user has purchased via the product ordering and fulfillment application and the corresponding search causes a search of the user's prior purchase history and the auction records.

12. The method of claim 7, wherein one of the monitoring views comprises auctions in which a user has placed a bid but lost the auction and the corresponding search causes a search of a prior bid history and records of closed auctions.

13. Computer readable medium having program instructions stored thereon that define:
an auction management application to conduct auctions on an automated basis and develop auction records representing them,
a product ordering and fulfillment application to manage customer orders and develop product records representing them,
an auction monitoring tool, comprising:
a navigation frame presenting a plurality of monitoring views, each view corresponding to a search among one or more of the auction management database records and the product ordering and fulfillment database records, and
a detailed record view,
a search tool, responsive to operator selection of a monitoring view, to execute the corresponding search among the auction management database records and/or the product ordering and fulfillment database records and generate a results page representing search results obtained therefrom.

14. The medium of claim 13, wherein one of the monitoring view comprises active auctions in which a user has placed a bid, the corresponding search causing a search of a prior bid history of the user and the auction records.

15. The medium of claim 14, wherein the view of active auctions in which a user has placed a bid is the first of any auction views to be displayed.

16. The medium of claim 13, wherein one of the monitoring views comprises active auctions the user has viewed in a detailed view, the corresponding search causing a search of a prior view history of the user and the auction records.

17. The medium of claim 13, wherein one of the monitoring view comprises auctions that include products a user has purchased via the product ordering and fulfillment application, the corresponding search causing a search of the user's prior purchase history and the auction records.

18. The medium of claim 13, wherein one of the monitoring view comprises auctions in which a user has placed a bid but lost the auction, the corresponding search causing a search of a prior bid history and records of closed auctions.
